(19) United States
(12) Patent Application Publication
(10) Pub. No.: US 2015/0190786 A1
(43) Pub. Date: Jul. 9, 2015

(54) Catalyst Carrier and Exhaust Gas Purifying Catalyst

(71) Applicant: Mitsui Mining & Smelting Co., Ltd., Tokyo (JP)

(72) Inventors: Yasunori Imada, Ageo-shi (JP); Hidekazu Kanemitsu, Ageo-shi (JP)

(21) Appl. No.: 14/419,782

(22) PCT Filed: Jul. 12, 2013
(86) PCT No.: PCT/JP2013/069134

§ 371 Date: Feb. 5, 2015

(30) Foreign Application Priority Data
Aug. 31, 2012 (JP) 2012-192097

(51) Int. Cl. B01J 23/44; B01J 23/10

(52) U.S. Cl. CPC B01J 23/44; B01J 23/10

(57) ABSTRACT

Provided is a catalyst carrier which contains an apatite-type composite oxide and provides a catalyst carrier which can enhance NOx purifying performance by means of improvement of phosphorus poisoning. Provided is a catalyst carrier which contains a composite oxide expressed by the following composition formula: LaₓPr_{y}M_{10.00-x-y}(Si_{6.00-w}N_{w})O_{27.00-z} (wherein 2.50≦x≦6.00, 2.50≦y≦6.00, 5.00≦x+y≦9.50, 0.00≦z≦3.00, 0.00≦w≦3.00, M represents one or two or more elements selected from alkaline earth metal elements and rare earth elements, and N represents at least one kind of cation element).

### TECHNICAL FIELD

The present invention relates to a catalyst carrier for supporting a catalyst active component and an exhaust gas purifying catalyst using the catalyst carrier.

### BACKGROUND ART

An exhaust gas of an internal combustion engine such as an automobile which use gasoline for fuel contains hazardous components such as hydrocarbon (THC), carbon monoxide (CO), and nitrogen oxide (NOx). It is necessary to simultaneously purify and exhaust each of the hazardous components using an oxidation-reduction reaction. For example, it is necessary to purify in such a manner that the hydrocarbon (THC) is converted into water and carbon dioxide by oxidation; the carbon monoxide (CO) is converted into the carbon dioxide by oxidation; and the nitrogen oxide (NOx) is converted into nitrogen by reduction.

As a catalyst (hereinafter, referred to as an “exhaust gas purifying catalyst”) adapted to treat these exhaust gases from the internal combustion engine, three way catalysts (TWC) capable of oxidizing and reducing CO, THC, and NOx have been used.

These kinds of the three way catalysts are well known, in which a precious metal is supported on a refractory oxide porous body such as, for example, an alumina porous body having a high-specific surface area and the precious metal is supported on a substrate, for example, a monolithic substrate made of a refractory ceramic or metallic honeycomb structure or on refractory particles.

Since a binding force between the precious metal as a catalyst active component and the substrate is not so strong, it is difficult to sufficiently secure a supported amount even when the precious metal is intended to be directly supported on the substrate. In order to support the sufficient amount of catalyst active component on a surface of the substrate, therefore, the precious metal has been supported on a catalyst carrier having a high specific surface area.

A porous body consisting of silica or alumina and a refractory inorganic oxide such as a titania compound is known as the catalyst carrier from the related art. Further, in recent years, a catalyst carrier consisting of an apatite-type composite oxide has received the attention as a catalyst carrier which has excellent heat resistance and can prevent sintering of metal catalyst particles supported thereon.

As the catalyst carrier consisting of the apatite-type composite oxide, for example, Patent Document 1 (JP 7-24323 A) discloses a catalyst carrier consisting of an apatite-type compound expressed by a general formula: M₁₀.(ZO₄)₆.X₂ (where, some or all of M contain 0.5 to 10 wt % of one or two or more transition metals selected from Group 1B and/or Group 8 of the Periodic Table and preferably one or two or more transition metals selected from copper, cobalt, nickel, and/or iron, Z represents a cation of 3- to 7-valent, and X represents an anion of 1- to 3-valent).

As a catalyst which achieves exhaust gas purification effect even in a relatively low temperature state and achieves purification performance as a ternary catalyst even in a high temperature range, Patent Document 2 (JP 2007-144412 A) discloses an exhaust gas purifying catalyst consisting of a composite oxide expressed by (Laₐ₋ₓMₓ) (Si_{6-y}N_{y})O_{27-z} and a precious metal component that exists in the composite oxide as a solid solution or is supported on the composite oxide, which exhibits high low-temperature activity and excellent heat resistance, and which can obtain stable exhaust gas purification performance.

Patent Document 3 (JP 2011-16124 A) discloses an exhaust gas purifying catalyst consisting of a complex oxide expressed by a general formula: (A_{a-w-x}M_{w}M′ₓ) (Si_{6-y}N_{y})O_{27-z} (in the formula, A is a cation of at least one of La and Pr; M is a cation of at least one of Ba, Ca, and Sr; M′ is a cation of at least one of Nd, Y, Al, Pr, Ce, Sr, Li, and Ca; N is a cation of at least one of Fe, Cu, and Al, and the following are satisfied: 6≦a≦10, 0<w<5, 0≦x<5, 0<w+x≦5, 0≦y≦3, 0≦z≦3, A≠M′, where x≠0 when A is a cation of La) and a precious metal component that exists in the composite oxide as a solid solution or is supported on the composite oxide.

### CITATION LIST

### Patent Document

Patent Document 1: JP 7-24323 A

Patent Document 2: JP 2007-144412 A

Patent Document 3: JP 2011-16124 A

### DISCLOSURE OF THE INVENTION

### Problem to be Solved by the Invention

The apatite-type composite oxides disclosed in Patent Documents 1 and 3 described above have a problem in that NOx purifying performance is not sufficient, while having excellent characteristics in which heat resistance is excellent and the supported metal catalyst particles can be prevented from being sintered. The reason is considered that a phosphorus component contained in the exhaust gas easily comes in contact with the catalyst in the case of supporting the catalyst active component on the apatite-type composite oxide and thus the NOx purifying performance is degraded.

Here, the invention relates to a catalyst carrier containing an apatite-type composite oxide and is to provide a novel catalyst carrier which can increase NOx purifying performance by improvement of phosphorus poisoning.

### Means for Solving Problem

The invention is to provide a catalyst carrier containing a composite oxide expressed by the following composition formula: LaₓPr_{y}M_{10.00-x-y}(Si_{6.00-w}N_{w})O_{27.00-z} (wherein 2.50≦x≦6.00, 2.50≦y≦6.00, 5.00≦x+y≦9.50, 0.00≦z≦3.00, 0.00≦w≦3.00, M represents one or two or more elements selected from alkaline earth metal elements and rare earth elements, and N represents at least one kind of cation element).

### Effect of the Invention

According to the catalyst carrier provided by the invention, since the apatite-type composite oxide contains Pr, the surface of the catalyst can be increased in basicity, thereby phosphorus capturing performance can be enhanced and phosphorus poisoning can be improved, resulting in increasing the NOx purifying performance.

### MODE(S) FOR CARRYING OUT THE INVENTION

Next, the invention will be described based on an embodiment. However, the invention is not intended to be limited to the embodiment described below.

<Present Catalyst Carrier>

A catalyst carrier (hereinafter, referred to as a “present catalyst carrier”) according to an example of the embodiment of the invention is a catalyst carrier containing a composite oxide (hereinafter, referred to as a “present complex oxide”) expressed by the following composition formula: LaₓPr_{y}M_{10.00-x-y}(Si_{6.00-w}N_{w})O_{27.00-z} (wherein 2.50≦x≦6.00, 2.50≦y≦6.00, 5.00≦x+y≦9.50, 0.00≦z≦3.00, 0.00≦w≦3.00, M represents one or two or more elements selected from alkaline earth metal elements and rare earth elements, and N represents at least one kind of cation element)

Preferably, the symbol M in the composition formula (1) represents a combination of one or more elements selected from the alkaline earth metal elements and one or more elements selected from the rare earth elements.

In addition, the symbol M in the composition formula (1) preferably includes one or two or more elements selected from the group consisting of Ca, Sr, Ba, and Ra as the alkaline earth metal element, more preferably includes at least Ba or Sr, and most particularly preferably includes Ba.

Meanwhile, the symbol M preferably includes at least Y or Nd as the rare earth element and more particularly preferably includes Y.

Among the above, the symbol M in the composition formula (1) preferably includes one or two or more elements selected from the group consisting of Ba, Sr, Y, and Nd and more particularly preferably includes Ba and Y.

The symbol N in the composition formula (1) may be at least one kind of cation element. An example thereof may include Fe, Cu, or Al and may be one or more of them.

In the composition formula (1), “x” indicating a moral ratio of La is preferably in the range of 2.50 to 6.00 and more preferably 3.00 or more or 5.00 or less.

In addition, “y” indicating a moral ratio of Pr is preferably in the range of 2.50 to 6.00 and more preferably 3.00 or more or 5.00 or less.

“x+y” indicating a total moral ratio of La and Pr is preferably in the range of 5.00 to 9.50 and more preferably 6.00 or more or 9.00 or less.

“w” in “6.00−w” indicating a moral ratio of Si and “w” indicating a moral ratio of N are preferably in the range of 0.00 to 3.00.

“z” in “27.00−z” indicating a moral ratio of O is preferably in the range of 0.00 to 3.00, more preferably 0.50 or more or 2.50 or less, and most particularly preferably 0.70 or more or 2.00 or less.

The fact that the catalyst carrier contains the complex oxide represented by the composition formula can be confirmed depending on diffraction peaks of an X-ray diffraction (XRD).

The present catalyst carrier may contain carrier components other than the present complex oxide, for example, a porous body of the compound selected from a group consisting of a silica compound, an alumina compound, and a titania compound and more specifically other carrier components such as a porous body consisting of the component selected from, for example, alumina, silica, silica-alumina, alumino-silicate, alumina-zirconia, alumina-chromia, and alumina-ceria.

The present catalyst carrier may have a particulate shape or other shapes.

In the present catalyst carrier, the complex oxide consisting of a raw material, for example, La_{4.0}Pr_{3.53}Ba_{1.00}Si_{6.00}O_{25.50} is produced in such a manner that lanthanum nitrate, barium nitrate, praseodymium nitrate, colloidal silica, and other raw material components as needed are added to deionized water and the resultant mixture was stirred, thereby obtaining a transparent solution; the transparent solution is dropped to a mixture solution of ammonia water and ammonium carbonate, thereby precipitating a precipitate by hydrolysis; the obtained precipitate is aged at a predetermined temperature and then washed with water, followed by filtration and drying, thereby obtaining a precursor; and then the precursor is calcined at 900° C. under the atmosphere, resulting in obtaining the complex oxide. However, it is not limited to such a producing method.

<Present Exhaust Gas Catalyst>

An exhaust gas catalyst as an example of the embodiment according to the invention (hereinafter, referred to as “present catalyst”) is an exhaust gas purifying catalyst that contains the present catalyst carrier, an catalyst active component which exists in the present catalyst carrier as a solid solution or is supported on the present catalyst carrier, an OSC material as needed, and other components.

(Catalyst Active Component)

The present catalyst may contain a metal such as, for example, palladium (Pd), platinum, rhodium, gold, silver, ruthenium, iridium, nickel, cerium, cobalt, copper, osmium, or strontium, as a catalyst active component.

The present catalyst more preferably contains platinum (Pt) or palladium (Pd) and most preferably contains palladium (Pd).

(OSC Material)

Preferably, the present catalyst may contain a promoter (OSC material) having oxygen storage capacity (OSC).

The OSC material may include, for example, a cerium compound, a zirconium compound, a ceria-zirconia complex oxide, or the like.

(Other Components)

The catalyst may contain other components such as a stabilizer other than the above component.

The stabilizer may include, for example, an alkaline-earth metal or an alkaline metal. Preferably, the stabilizer can be selected from one kind or two or more kinds of metals selected from a group consisting of magnesium, barium, boron, thorium, hafnium, silicon, calcium, and strontium. Among them, the barium is preferred in terms of having the highest temperature at which PdOx is reduced, that is, in terms of being hard to be reduced.

In addition, the stabilizer may include a known additive component such as a binder component.

The binder component may use inorganic binder, for example, an aqueous solution such as an alumina sol.

(Form of Present Catalyst)

The present catalyst can be used alone as a catalyst by being molded in the form of an appropriate shape such as a pellet and can be used as a form of being supported on a substrate consisting of ceramics or metal materials.

(Substrate)

The material of the substrate may include refractory materials such as a ceramics, or metal materials.

The material of the ceramic substrate may include a refractory ceramic material, for example, cordierite, cordierite-alpha alumina, silicon nitride, zircon mullite, spodumene, alumina-silica magnesia, zircon silicate, sillimanite, magnesium silicate, zircon, petalite, alpha alumina, alumino-silicates, and the like.

The material of the metal substrate may include a refractory metal, for example, other suitable corrosion-resistant alloys based on stainless steel or iron.

The shape of the substrate may include a honeycomb shape, a pellet shape, or a spherical shape.

The honeycomb material may use, for example, a cordierite material such as the ceramics. In addition, the honeycomb material may use the honeycomb formed of a metal material such as ferritic stainless steel.

(Method of Producing Present Catalyst)

An example of the method of producing the present catalyst may include a method of: obtaining a slurry by mixing and stirring the present catalyst carrier, the catalyst active component, the OSC material as needed, the stabilizer, the binder, and water with each other; coating the obtained slurry onto the substrate such as, for example, a ceramic honeycomb body by a wash coat; and calcining the slurry-coated substrate, thereby forming a catalyst layer on the surface of the substrate.

In addition, the method of producing the present catalyst may include a method of: obtaining a slurry by mixing and stirring the present catalyst carrier, the OSC material as needed, the stabilizer, the binder, and water with each other; and coating the obtained slurry onto the substrate such as, for example, a ceramic honeycomb body by a wash coat, thereby forming a catalyst carrier layer; subsequently immersing the catalyst carrier layer into a solution in which the catalyst active component is dissolved to absorb the catalyst active component on the catalyst carrier layer; and calcining the catalyst active component-absorbed catalyst carrier layer, thereby forming a catalyst layer on the surface of the substrate.

In addition, the method of producing the present catalyst may include a method of: obtaining a slurry by mixing and stirring, for example, a catalyst active component carrier in which the catalyst active component is supported on the oxide, the present catalyst carrier, the OSC material as needed, the stabilizer, the binder, and the water; coating the obtained slurry onto the substrate; and calcining the slurry-coated substrate, thereby forming a catalyst layer on the surface of the substrate.

Furthermore, the method of producing the present catalyst can employ all of the known methods, and is not limited to the above examples.

In any method of producing the present catalyst, the catalyst layer may be a single layer or multilayers of two or more layers.

<Explanation of Expressions>

In this specification, when the expression “X to Y” (X and Y are arbitrary numbers) is used, unless otherwise explicitly mentioned, the meaning of “X or greater but Y or lower” is included and at the same time, the meaning of “preferably greater than X” or “preferably less than Y” is included.

In addition, the expression “X or greater” (X is arbitrary number) or “Y or less” (Y is any number) includes the intention of “it is preferable to be greater than X” or “it is preferable to be less than Y”.

### EXAMPLES

Hereinafter, the invention will be described in detail based on following Examples and Comparative examples.

### Example 1

Lanthanum nitrate, barium nitrate, praseodymium nitrate, and colloidal silica weighed so as to be a composition ratio of La_{4.0}Pr_{3.53}Ba_{1.00}Si_{6.00}O_{25.50} were added to deionized water and the resultant mixture was stirred, thereby obtaining a transparent solution. The transparent solution was dropped to a mixture solution of ammonia water and ammonium carbonate, thereby obtaining a precipitate. The obtained precipitate was aged at 40° C. for 24 hours and then washed with water, followed by filtration and drying at 100° C., thereby obtaining a precursor. Then, the precursor was calcined at 900° C. for six hours, thereby obtaining a complex oxide.

The composition of the obtained complex oxide was analyzed by X-ray diffraction (XRD), and La_{4.0}Pr_{3.53}Ba_{1.00}Si_{6.00}O_{25.50} was confirmed depending on an analyzed diffraction peak.

The complex oxide of 90 parts by mass consisting of the obtained La_{4.0}Pr_{3.53}Ba_{1.00}Si_{6.00}O_{25.50}, a sol of 10 parts by mass (referred to as an “alumina sol”) in which Al₂O₃ was a dispersed material, and water of 130 parts by mass were mixed with each other in a ball mill, thereby obtaining slurry A.

In addition, activated alumina of 30 parts by mass, CeZrO₂ of 60 parts by mass, alumina sol of 10 parts by mass, and water of 150 parts by mass were mixed with each other in the ball mill, thereby obtaining slurry B.

A cordierite honeycomb substrate was immersed in the slurry B and pulled out therefrom, and then excess slurry was blown off. Subsequently, the substrate was dried at 90° C. for 10 minutes and calcined at 600° C. for three hours, resulting in forming a coat layer and thus obtaining a honeycomb substrate with the coat layer. The amount of the coat layer was 160 g per 1 L of the honeycomb substrate.

The obtained honeycomb substrate with the coat layer was immersed in a Pd nitrate solution and pulled out therefrom, and then excess droplets were blown off. Thereafter, the honeycomb substrate was dried at 90° C. for 10 minutes and calcined at 600° C. for three hours, thereby supporting Pd of 0.60 g per 100 g of the coat layer (corresponding to 1 L of the honeycomb base material), resulting in forming a first precious-metal-supported layer.

Subsequently, the honeycomb substrate on which the first precious-metal-supported layer had been formed was immersed in the slurry A and pulled out therefrom, and then excess slurry was blown off. Thereafter, the honeycomb substrate was dried at 90° C. for 10 minutes and calcined at 600° C. for three hours, resulting in forming a coat layer and thus obtaining a honeycomb substrate with the coat layer. The amount of the coat layer was 100 g per 1 L of the honeycomb substrate.

The obtained honeycomb substrate with the coat layer was immersed in the Pd nitrate solution and pulled out therefrom, and then excess droplets were blown off. Thereafter, the honeycomb substrate was dried at 90° C. for 10 minutes and calcined at 600° C. for three hours, thereby supporting Pd of 0.20 g per 100 g of the coat layer (corresponding to 1 L of the honeycomb base material) and thus forming a second precious-metal-supported layer, resulting in obtaining an exhaust gas purifying catalyst including an exhaust gas purifying catalyst layer supported on a carrier.

### Example 2 and Comparative Examples 1 and 2

An complex oxide and an exhaust gas purifying catalyst were prepared by the same manner as in Example 1 except that required raw materials such as lanthanum nitrate, barium nitrate, praseodymium nitrate, and colloidal silica were weighed so as to be a composition ratio indicated in Table 2, these required raw materials were added to deionized water, and the resultant mixture was stirred, thereby obtaining a transparent solution.

The composition of the complex oxide obtained in the same manner as in Example 1 was analyzed by X-ray diffraction (XRD), and compositions indicated in Table 2 were confirmed depending on analyzed diffraction peaks.

<Test of Exhaust Gas Purifying Performance (Phosphorus-Poisoning Durability Test)>

In order to confirm whether the exhaust gas purifying catalysts prepared by Examples and Comparative Examples were maintaining catalyst activity or, particularly, were influenced by phosphorus poisoning even after an automobile was driven under certain conditions, an accelerated deterioration test (durability test) was performed using an actual automobile engine.

First, the exhaust gas purifying catalysts prepared by Examples and Comparative Examples were mounted into exhaust pipe and a thermocouple was inserted into a center of the honeycomb. The exhaust pipe was set in the engine, and speed and torque of the engine were adjusted such that a temperature of the thermocouple was 750° C.±20° C. At this time, a cycle test was repeated such that A/F was 14 and 15 every a prescribed period, an engine oil of 6 mL per hour was added to an upstream side of the catalyst to promote phosphorus poisoning, and the durability test was performed for 150 hours.

After the durability test, each of the exhaust gas purifying catalysts which were cored into 15 cc was separately charged into an evaluation apparatus. A purification rate of NOx was continuously measured by allowing an exhaust model gas having the composition indicated in Table 1 to be described below to be flowed into the evaluation apparatus at a space velocity of 100,000/h and raising a temperature up to 500° C. at a temperature rise rate of 20° C./minute.

A temperature (T50) (° C.) at which the model gas was purified by 50% and the purification rate (1400) (%) of the model gas in the temperature of 400° C. were measured, and the measured results were indicated in Table 2.

TABLE 1

| A/F | CO | H₂ | O₂ | NO | C₃H₆ | CO₂ | H₂O | N₂ |
|---|---|---|---|---|---|---|---|---|
| 14.6 | 0.50% | 0.17% | 0.50% | 500 | 1200 | 14% | 10% | bal. |
| | | | | ppm | ppm | | | |

TABLE 2

| | | T50 (° C.) | η400 (%) |
|---|---|---|---|
| | | of NOx | of NOx |
| Example 1 | La(4.80)Pr(3.53)Ba(1.00)Si(6.00)O(25.50) | 315 | 98.0 |
| Example 2 | La(4.00)Pr(3.30)Ba(1.00)Y(1.00)Si(6.00)O(25.50) | 313 | 98.2 |
| Comparative | La(7.33)Ba(1.00)Pr(1.00)Si(6.00)O(25.83) | 345 | 92.3 |
| Example 1 | | | |
| Comparative | Pr(6.33)Ba(2.00)Y(1.00)Si(6.00)O(25.00) | 343 | 94.3 |
| Example 2 | | | |

In comparison to the apatite-type composite oxides of Comparative Examples 1 and 2, according to the apatite-type composite oxides of Examples 1 and 2, it was found that phosphorus capturing performance could be enhanced and the phosphorus poisoning could be improved, resulting in increasing the NOx purifying performance.

1. A catalyst carrier containing a composite oxide expressed by the following composition formula: LaₓPr_{y}M_{10.00-x-y}(Si_{6.00-w}N_{w})O_{27.00-z} (wherein 2.50≦x≦6.00, 2.50≦y≦6.00, 5.00≦x+y≦9.50, 0.00≦z≦3.00, 0.00≦w≦3.00, M represents one or two or more elements selected from alkaline earth metal elements and rare earth elements, and N represents at least one kind of cation element).

2. The catalyst carrier according to claim 1, wherein “M” in the formula includes one or two or more elements selected from the group consisting of Ba, Sr, Y, and Nd.

3. An exhaust gas purifying catalyst containing the catalyst carrier according to claim 1 and a catalyst active component that exists in the catalyst carrier as a solid solution or is supported on the catalyst carrier.

4. An exhaust gas purifying catalyst containing the catalyst carrier according to claim 2 and a catalyst active component that exists in the catalyst carrier as a solid solution or is supported on the catalyst carrier.
